(19) United States
(12) Patent Application Publication
(10) Pub. No.: US 2016/0087863 A1
(43) Pub. Date: Mar. 24, 2016

(54) Infering Management State via Secondary State

(71) Applicant: MICROSOFT CORPORATION, Redmond, WA (US)

(72) Inventors: Alemeshet Yismaw Alemu, Issaquah, WA (US); Neil Adam Jacobson, Acton, MA (US); Meera Jindal, Medford, MA (US)

(21) Appl. No.: 14/490,960

(22) Filed: Sep. 19, 2014

(51) Int. Cl. H04L 12/26

(52) U.S. Cl. CPC H04L 43/08

(57) ABSTRACT

Determining whether or not a device is managed. A method includes, as part of running a particular application, determining whether or not certain state and/or data (such as a particular specialized font, a particular certificate chain, or particular xml policy setting) is present on the device. When the certain state and/or data is present on the device, the method includes determining that the device is managed, otherwise, determining that the device is not managed.

### BACKGROUND

### Background and Relevant Art

Computers and computing systems have affected nearly every aspect of modern living. Computers are generally involved in work, recreation, healthcare, transportation, entertainment, household management, etc.

Handheld mobile computing devices have become ubiquitous. For example, many people have so-called smart phones or tablet computers. Such devices allow users to use cellular data systems or other network systems to access a broad spectrum of services. For example, using such devices, a user can access email, the Internet, on-line databases, etc. People who have personal smart phones (or other smart devices) may often want to use these personal devices to access company resources belonging to the companies by which they are employed.

IT administrators are able today manage mobile devices to configure, monitor and evaluate compliance for mobile devices through various policy management systems. They do this to protect corporate services and data.

Certain modern operating systems, and often certain operating systems on mobile device, do not provide the ability to detect if the system is under management. Thus, an agent embedded in an application cannot detect if the operating system is managed and if managed apply and remediate policy.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for determining whether or not a device is managed. The method includes, as part of running a particular application, determining whether or not certain state and/or data (such as a particular specialized font, a particular certificate chain, or particular xml policy setting) is present on the device. When the certain state and/or data is present on the device, the method includes determining that the device is managed, otherwise, determining that the device is not managed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates an environment where a device can use specialized data or state to determine that the device is managed;

FIG. 2 illustrates a method of determining whether or not a device is managed;

FIG. 3 illustrates another method of determining whether or not a device is managed; and

FIG. 4 illustrates yet another method of determining whether or not a device is managed.

### DETAILED DESCRIPTION

Some embodiments described herein can provide functionality to detect if a device is managed without requiring a call to a service. For example, embodiments can infer that a device is managed by using the existence of a secondary piece of state and/or information. For example, in some embodiments, a specialized font may be installed on a device. The existence of the font indicates that the device is managed. In an alternative embodiment, a security certificate may be installed which indicates that the device is managed. In yet another alternative embodiment, an xml setting may be set on the device.

Thus, inferring that a device is managed is not necessarily done by an API but using the existence of a secondary piece of state and/or information. Normally a management agent can detect that a device is managed directly through the use of an API, such as ‘IsManaged( )’ for products from Microsoft Corporation of Redmond, Wash., or through the use of configuration information, such as the registry, a configuration entry or the existence of a file. IOS, available from Apple Corporation of Cupertino, Calif., is so tightly locked down, that the application cannot read data outside of its sandbox, and there is no way to set a global setting from within an application. Thus, a registry setting, configuration entry, or file cannot be used to indicate that a device is managed.

Various different pieces of state and/or information can be used to indicate that a device is managed. Some devices may include functionality for allowing an administrator to push down a font to a device. In this embodiment, a management service (such as Intune available from Microsoft Corporation of Redmond, Wash.) pushes the font to the device. Then an agent embedded in the application queries for the existence of this font. By giving this font a unique and unlikely name, the agent can infer that the device has entered a managed state when the font is detected, because a user would not have this font on their device otherwise. If the administrator wants to stop managing the machine, they remove the font, and from that, the agent for the application can infer, that because the font is no longer present, the device is no longer managed.

In alternative embodiments, a pair of certificates that chain together are used. The management service has the ability to push down a root certificate to the device certificate chain. The application calls a known endpoint to get a child certificate—that is a certificate that has a chain of trust to the root certificate installed in the device certificate chain. The application can use operating system calls to verify that this child certificate still chains up to the root and use this information to infer that the device is managed. If the chain of trust is broken, because the certificate has been removed by the administrator, the application knows that it is no longer in managed state and should take a corrective action.

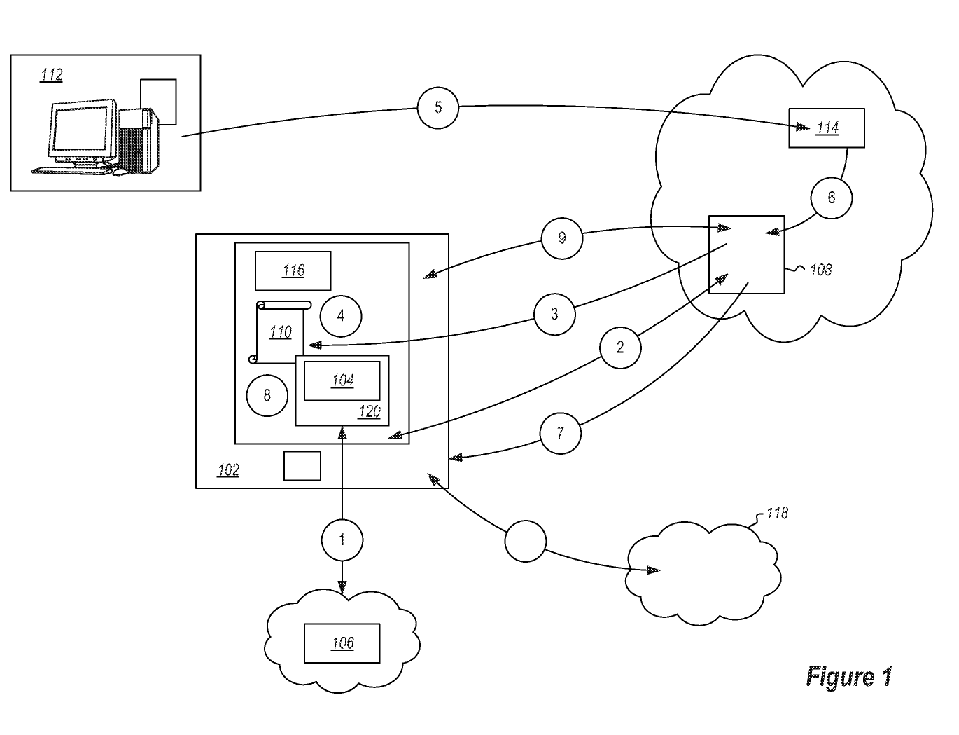

Referring now to FIG. 1, a detailed example of various actions that can be performed in accordance with some embodiments illustrated herein is shown. In the example illustrated in FIG. 1, at step 1, a device 102 installs an application 104 through an app store 106. Alternatively, the application can come from side loading or though mobile device management (MDM). At step 2, the user registers the device 102 for management through a MDM gateway 108. At step 3, the device 102 is enrolled for management with the MDM gateway 108 and state and/or information 110 is passed to the device 102. For example, the state and/or information may be a font as described previously. In an alternative embodiment, the state and/or information may be the certificates as described above. The state and/or information 110 may be tied to a management profile 116 at the device 102. At step 4, the MDM registration registers the state and/or other information 110 on the device 102. This may be done by registering with the management profile 116. The application 104 updates its state to indicate that it is on a managed device after it has verified the state and/or other information 110. The application 104 will then behave as being on a managed device.

An application being on a managed device will typically result in controls on that application's functionality and/or controls on data produced and/or used by the application. For example, when an application is on a managed device, there may be controls on how data can be accessed and used. As examples, embodiments may wish to prevent a user from using cut and paste functionality in a managed application to make migration of corporate data outside of a managed environment more difficult. Alternatively or additionally, embodiments may wish to protect corporate data such that when a device is not managed, corporate data cannot be accessed and is not allowed to be stored on the unmanaged device. Thus, for example, if while a device is a managed device, the device accesses and stores, or creates corporate data, and at a later time the device becomes no longer managed, any corporate data stored on the device will be wiped from the device.

Wiping this data from the device can be done in a number of different ways. For example, in some embodiments, the device can be totally wiped of all data, corporate or otherwise. Alternatively, the device may have only corporate data wiped in a selective wipe operation while leaving personal or other data.

The controls on functionality and data access can be implemented using a wrapper 120 around the application 104.

Returning once again to the depiction illustrated in FIG. 1, various actions are illustrated for retiring a device—that is, removing a device from being managed. As illustrated in FIG. 1, an administrator at a console 112 indicates that the device 102 should be retired. At step 5, the console 112 sends a retire command for the device 102 to a management service 114. The console 112 in some embodiments, may be an Office 365 management console available from Microsoft Corporation of Redmond, Wash. In some embodiments, the management service 114 may be an Intune service available from Microsoft Corporation of Redmond, Wash. As illustrated at step 6, a retire command is sent from the management service 114 to the MDM gateway 108. As illustrated at step 7, a retire command is sent to the device 102. As illustrated at step 8, the state and/or information 110 is removed from the device 102. The management profile 116 at the device 102 may also be removed from the device 102. The next time the application 104 is launched, it will detect that the state and/or information 110 is missing or invalid. For example, if the font has been removed from the device 102 or the child certificate is no longer valid and cannot link up to the parent certificate because the parent certificate has been removed, then the application can determine that the device 102 is no longer managed. At this point, a wipe or selective wipe can be performed to remove corporate data from the device 102.

Various embodiments may implement periodic or other time based controls over device management. For example, in embodiments where a child certificate is used to indicate that a device 102 is managed, the certificate may expire or become invalid. If the certificate expires or becomes invalid, the device 102 can contact the management service 114 through the gateway 108, as illustrated at step 9, to determine if the device 102 is still managed. If management service indicates that the device is not managed, then the device 102 can have the state and/or information 110 removed and can be wiped as described above. If the management service 114 indicates that the device 102 is still managed, then a new child certificate can be downloaded from a certificate service 118 to complete the trust chain so that a determination can be made that the device 102 is managed.

In alternative example, the device 102 can poll the management service 114 through the gateway 108 periodically to determine if the device 102 is still managed. If the management service 114 indicates in this polling that the device is no longer managed, then the device 102 can have the state and/or information 110 removed and can be wiped as described above.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

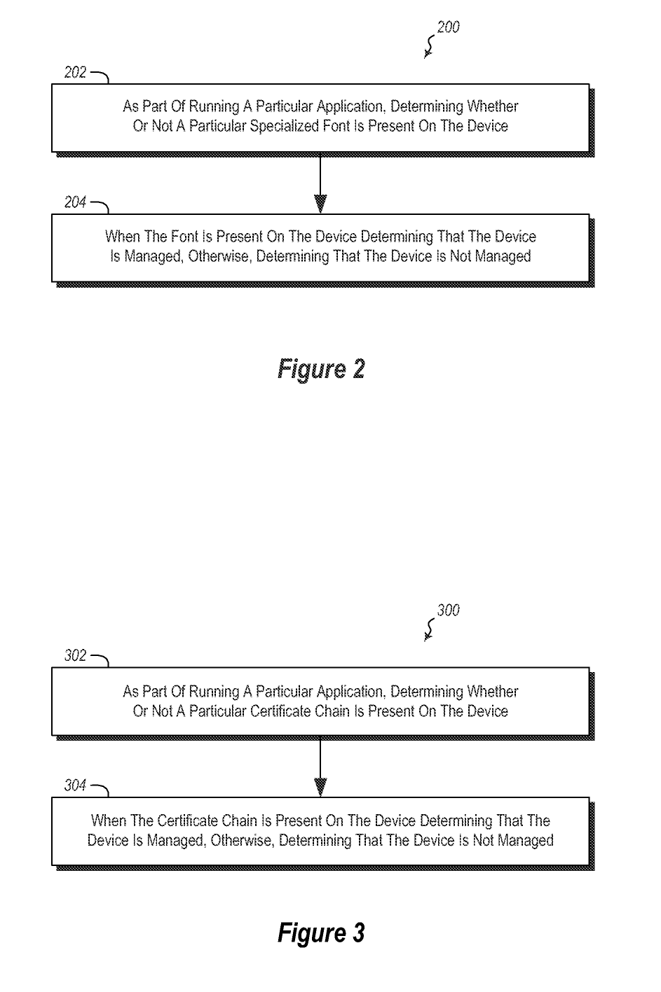

Referring now to FIG. 2, a method 200 is illustrated. The method 200 may be practiced in a computing environment. The method 200 includes acts for determining whether or not a device is managed. This can be done, in some embodiments: without needing to contact a management service or running an application as a super user. The method 200 includes, as part of running a particular application, determining whether or not a particular specialized font is present on the device (act 202). For example, as illustrated in FIG. 1, a determination can be made that the state and/or information 110 is present on the device 102, when the state and/or information is a specialized font file, such as a font with a unique or unusual name.

When the font is present on the device, the method of 200 further includes determining that the device is managed, otherwise, determining that the device is not managed (act 204).

When a determination is made that device is not managed, the method 200 may further include wiping the device.

The method 200 may be practiced where the font is pinned to a management profile, such as the management profile 116. For example, the font may be pinned to the management profile such that if the management profile is removed (meaning that the device is no longer managed) the font is also removed.

The method 200 may be practiced where the application is installed by side loading. Thus, embodiments may be implemented where the application is installed from a source other than an organization provided managed application repository (such as Company Portal provided by Microsoft Corporation of Redmond, Wash.). This can be accomplished by using the wrapper 120 which sits between the application 104 and the operating system of the device 102. The wrapper can be used to determine if the specialized font is on the device to determine if the device is managed and limit functionality and data access of the application accordingly.

Similarly, the method 200 may be practiced where the application is installed from an app store, instead of being pushed from a managed application repository). This can be accomplished by using the wrapper 120 which sits between the application 104 and the operating system of the device 102. The wrapper can be used to determine if the specialized font is on the device to determine if the device is managed and limit functionality and data access of the application accordingly.

However, the method 200 may be practiced where the application is installed from a managed application repository. In this example, the application 104 may include functionality for complying with management policies without the need for the wrapper 120.

The method 200 may further include checking for the font every time the application is run. Alternatively, the method 200 may further include, checking for the font on a periodic basis.

The method 200 may be practiced where determining if font is present occurs at a point later in time than install time for the application. The font can be installed at a later time than installation time for the application.

Referring now to FIG. 3, a method 300 is illustrated. The method 300 may be practiced in a computing environment. The method 300 includes acts for determining whether or not a device is managed. This can be done, in some embodiments: without needing to contact a management service or running an application as a super user. The method 300 includes, as part of running a particular application, determining whether or not a particular certificate chain is present on the device (act 302).

When the certificate chain is present on the device, the method 300 further includes determining that the device is managed, otherwise, determining that the device is not managed (act 304).

The method 300 may be practiced where when a determination is made that device is not managed, the method further includes wiping the device.

The method 300 may be practiced where the certificate chain is pinned to a management profile.

The method 300 may further include checking for the certificate chain every time the application is run.

The method 300 may further include, checking for the certificate chain on a periodic basis.

The method 300 may be practiced where determining if certificate chain is present occurs at a point later in time than install time for the application.

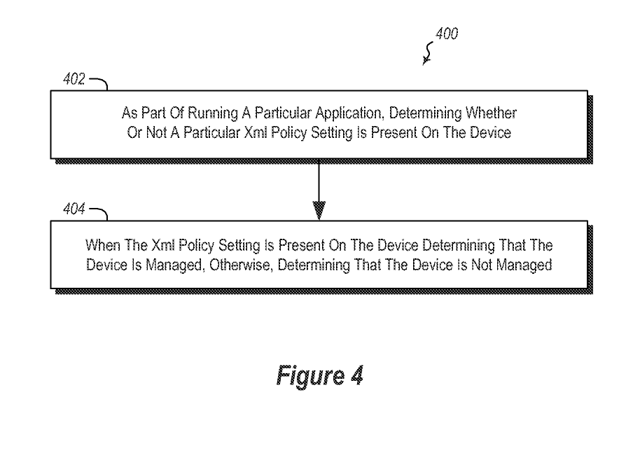

Referring now to FIG. 4, a method 400 is illustrated. The method 400 may be practiced in a computing environment. The method 400 includes acts for determining whether or not a device is managed. This can be done, in some embodiments: without needing to contact a management service or running an application as a super user. The method 200 includes, as part of running a particular application, determining whether or not a particular xml policy setting is present on the device (act 402).

When the xml policy setting is present on the device, the method 400 further includes determining that the device is managed, otherwise, determining that the device is not managed (act 404).

The method 400 may be practiced where when a determination is made that device is not managed, the method further includes wiping the device.

The method 400 may be practiced where the xml policy setting is pinned to a management profile.

The method 400 may further include, checking for the xml policy setting every time the application is run.

The method 400 may further include, checking for the xml policy setting on a periodic basis.

The method 400 may be practiced where determining if xml policy setting is present occurs at a point later in time than install time for the application.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include: Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of determining whether or not a device is managed, the method comprising:
as part of running a particular application, determining whether or not a particular specialized font is present on the device; and
when the font is present on the device determining that the device is managed, otherwise, determining that the device is not managed.

2. The method of claim 1, wherein when a determination is made that device is not managed, the method further includes wiping the device.

3. The method of claim 1, wherein that the font is pinned to a management profile.

4. The method of claim 1, wherein the application is installed by side loading.

5. The method of claim 1, wherein the application is installed from an app store (instead of being pushed from a managed application repository).

6. The method of claim 1, where the application is installed from a managed application repository.

7. The method of claim 1, further comprising, checking for the font every time the application is run.

8. The method of claim 1, further comprising, checking for the font on a periodic basis.

9. The method of claim 1, wherein determining if font is present occurs at a point later in time than install time for the application.

10. One or more computer-readable storage media, wherein the one or more computer-readable storage media comprise computer-executable instructions that when executed by at least one of the one or more processors cause the system to perform the following method:
as part of running a particular application, determining whether or not a particular certificate chain is present on the device; and
when the certificate chain is present on the device determining that the device is managed, otherwise, determining that the device is not managed.

11. The one or more computer-readable storage media of claim 10, wherein when a determination is made that device is not managed, the method further includes wiping the device.

12. The one or more computer-readable storage media of claim 10, wherein the certificate chain is pinned to a management profile.

13. The one or more computer-readable storage media of claim 10, the method further comprising, checking for the certificate chain every time the application is run.

14. The one or more computer-readable storage media of claim 10, the method further comprising, checking for the certificate chain on a periodic basis.

15. The one or more computer-readable storage media of claim 10, wherein determining if certificate chain is present occurs at a point later in time than install time for the application.

16. In a computing environment, a system for determining whether or not a device is managed the system comprising:
one or more processors; and
one or more computer-readable media, wherein the one or more computer-readable media comprise computer-executable instructions that when executed by at least one of the one or more processors cause the system to perform the following method:
as part of running a particular application, determining whether or not a particular xml policy setting is present on the device; and
when the xml policy setting is present on the device determining that the device is managed, otherwise, determining that the device is not managed.

17. The system of claim 19, wherein when a determination is made that device is not managed, the method further includes wiping the device.

18. The system of claim 19, wherein the xml policy setting is pinned to a management profile.

19. The system of claim 19, the method further comprising, checking for the xml policy setting every time the application is run.

20. The system of claim 19, the method further comprising, checking for the xml policy setting on a periodic basis.
